(19) United States
(12) Patent Application Publication
(10) Pub. No.: US 2014/0115099 A1
(43) Pub. Date: Apr. 24, 2014

(54) Method and System for Integrating Information from Mobile Devices to a Semantic Knowledge Repository

(71) Applicant: Nowshade Kabir, Woodbridge (CA)

(72) Inventor: Nowshade Kabir, Woodbridge (CA)

(21) Appl. No.: 13/943,795

(22) Filed: Jul. 17, 2013

Related U.S. Application Data
(60) Provisional application No. 61/672,288, filed on Jul. 17, 2012.

(51) Int. Cl. H04L 29/08; H04L 12/58

(52) U.S. Cl. CPC H04L 67/06; H04L 51/10; H04L 51/04
USPC 709/217

(57) ABSTRACT

This Invention proposes a new method and a system for integrating valuable information generated and residing in audio and multimedia conversation, conference calls, text or multimedia messages, Internet based text or multimedia instant messages, documents, webpages and emails from mobile devices or smart phones to an organization's knowledge repository. The proposed system is developed using semantic technologies and it makes knowledge integration and sharing from mobile devices simple, fast and reliable.

This application claims priority under 35 U.S.C #119 to the following provisional application: 61/672,288, filed on Jul. 17, 2012

### BACKGROUND OF THE INVENTION

1. Area of Invention

The idea behind this invention is to record and integrate telephone conversations, recorded conversation, text messaging, Internet based instant messaging sessions, multimedia and textual documents, webpages and emails on a mobile device or smart phone to a semantic knowledge repository.

2. State of the Art

Mobile devices and smartphones have become an extension of people's work ecosystem and complements office desktops and notebooks. Although, professionals are using them actively while they are on the go, lack of seamless integration of mobile devices and smartphones with organization's knowledge management systems makes the use of these devices, constrained and deny the possibilities of tapping into the full potential of a smartphone or other similar devices.

There are many systems available to record and transfer recorded audio, video and textual information to remote server. However, extant systems unlike the present invention do not embody a comprehensive information integration mechanism that allows automated information integration from mobile devices and smartphones to a semantic technology based knowledge repository. Our primary contribution in this invention is an end-to-end system that integrates multi media and textual content generated from the mobile devices and smart phones to a knowledge repository and makes them semantically searchable.

### SUMMARY OF THE INVENTION

The main object of the invention is to provide a set of systems and methods that is capable of recording and integrating audio and multimedia conversation or conference calls, text or multimedia messages, Internet based text or multimedia instant messages partially or fully, documents, webpages and emails from any mobile device or smartphones to a remote knowledge repository.

First object of the invention is to provide a system and method to record, save and retrieve audio and multimedia conversation or conference calls, text or multimedia messages, Internet based text or multimedia instant messages on any mobile device or smartphone.

The second object of the invention is to provide a data transfer and storage system and method to transmit and store saved audio and multimedia conversation or conference calls, text or multimedia messages and Internet based text or multimedia instant messages on any mobile device or smartphone to a remote server.

The third object of the invention is to provide a system and a method to transfer multimedia and textual documents, web pages and emails to a remote server.

Another object of the invention is to provide a conversion system and a method for stored audio and multimedia conversation or conference calls, text or multimedia messages, Internet based text or multimedia instant messages, multimedia and textual documents, web pages and emails to text data and documents.

A further object of the invention is to provide an ontology based information extraction and indexing system and method for producing semantically annotated information models.

Another object of the invention is to provide a context based categorization system and method to integrate the document to knowledge repository.

### DESCRIPTIONS OF THE DRAWINGS

FIG. 1: There are two distinct parts of the system: Application Side 100 and Cloud System Side 500. Application Side consists of User Interface 110, which can be in the form of a mobile device or smart phone's app of Android, Apple OS, Microsoft Windows Blackberry and other operational systems, Recorder 120—a phone conversation or meeting recorder program that works from within the app, and a Transfer Unit 130 that transfers multimedia files, documents, webpages, mails, messages, Internet clips and recorded conversations to a remote cloud server 521.

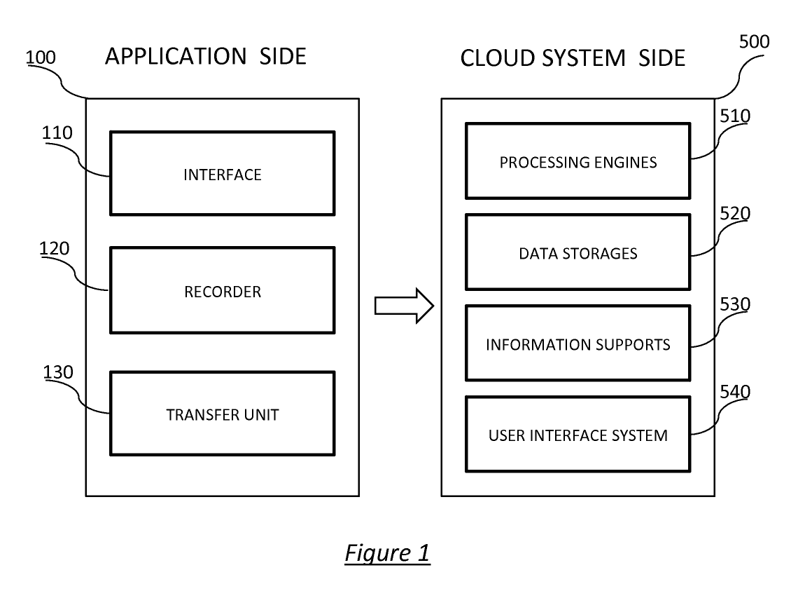

The Cloud System Side 500 comprises Processing Engines 510—these are several systems required for document integration from the transferred data from the mobile app to the Could System, Data Storages 520—multiple servers necessary for storing various types of data, Information Supports 530—various data necessary for the Processing Engines to work, User Interface System 540—GUI interface, search engine, portal and other necessary elements for effective use of the Semantic Knowledge Repository 550.

FIG. 2: Gives a total view of the invention from the system structure perspective. Mobile devices and smartphones that include tablet, phablets, Netbooks, PDA, mobile phones 50, where the app can be used. Data Storage servers 520, Processing Engines 510, Semantic Knowledge repository 550 include all necessary components of the repository and User Interface System 540.

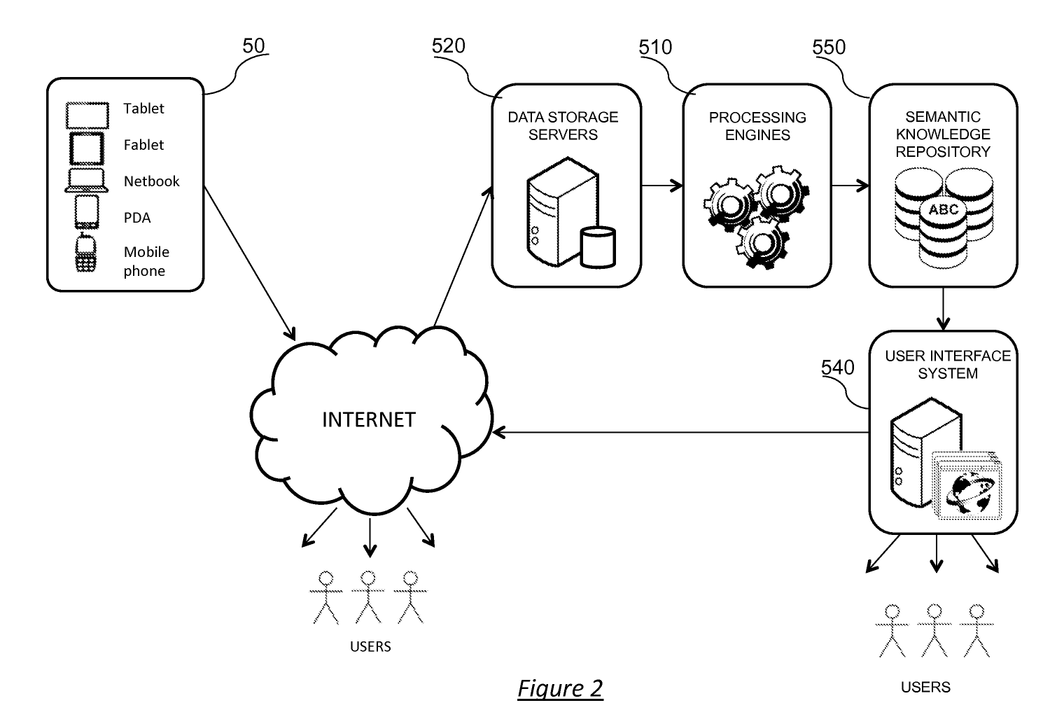

FIG. 3: This drawing describes the application side of system. The app allows the user either to auto activate or activate the app on demand 110. From the mobile application 104 the user can select documents, files, webpages, etc. 105 and using the app's capability 106 transfer 131 them to the remote cloud server 521. Transfer of all data from the mobile device or smart phone is encrypted. Recording System 125 according to user's command records telephone conversation 165, video conversation 170 and clip text messages or chat line sessions 175. These record files can be transferred 185 anytime by the user to the remote server 521.

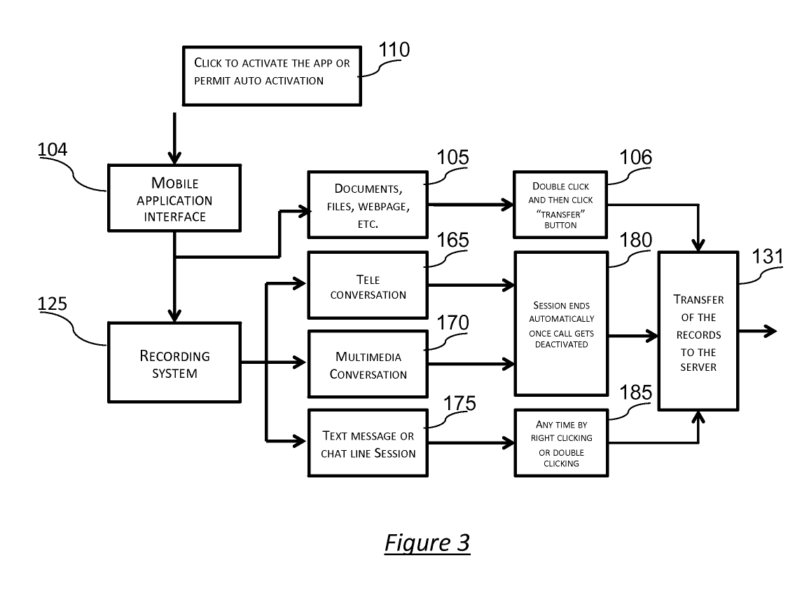

FIG. 4: The documents and files from the app 131 get stored in the raw data server 521 of the cloud system 500. Information conversion engine (ICE) 511, which is equipped with speech recognition program, natural language processing program (NLP) etc. converts the documents and files to a version of texts and unstructured documents and store them 522. Ontology based information extraction and indexing engine (OBIEI) 512 performs semantic annotating activity on the unstructured texts and documents 522 based on domain Ontologies and knowledge base 531,—Ontology is considered as an explicit representation of a shared understanding of the important concepts in some domain of interest. Ontologies usually are referred as a graph structure consisting of and a set of instances assigned to a particular concept. A Knowledge Base is a pre-populated collection of instances with appropriate domain knowledge, which enables inferring generalizations that are natural to human users. For example, Tiger Woods in the context of golf is a person not an animal and a material in plural form, Rule based annotations 532—Date normalizers attempt to determine a date instance, measurement taggers tries to identify measurements in various units and forms are examples of Rule-based annotations, and Processing resources 533, examples of these resources are parsers, generators or ngram modelers. The outcome of these activities is Semantically annotated content models 523. Context-based categorization engine 513 based on Category ontology—the existing classification system of the knowledge repository 550 classifies the document and stores in the Categorized document repository 524. Indexing of the data from the unstructured document is performed by OBIEI 512. This indexed data is stored in the Indexed data storage 525. Semantic portal 700 and Search engines 600 are required components for people to use the repository resources.

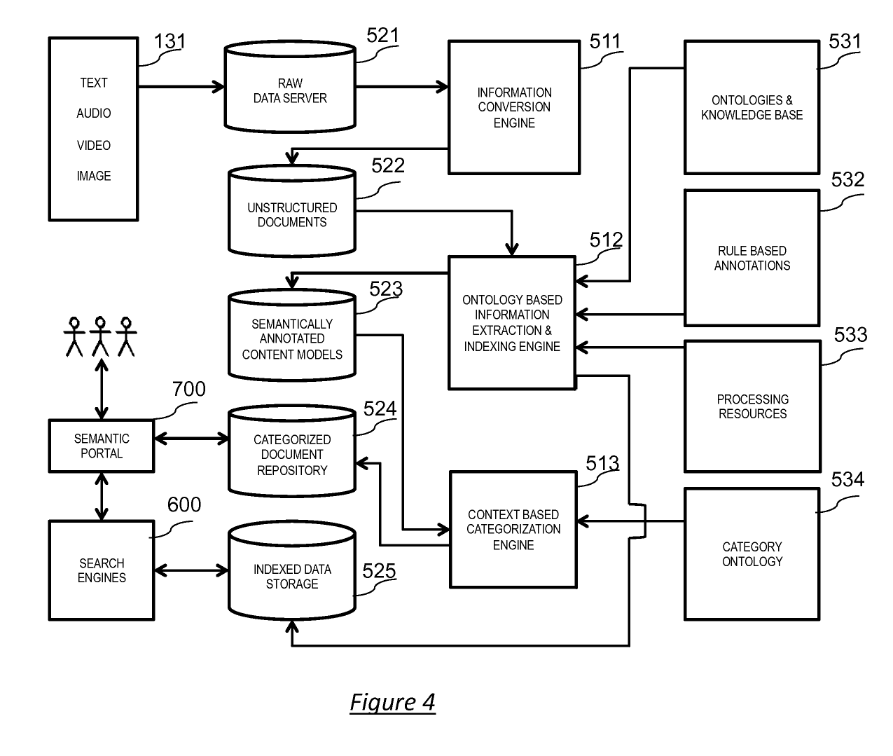

FIG. 5: Semantic Knowledge Repository is consists of storages of Unstructured documents 522, Semantically annotated content models 523, Categorized document repository 524 and Indexed data 525 and Ontologies and knowledge base 531 and Category Ontology 534.

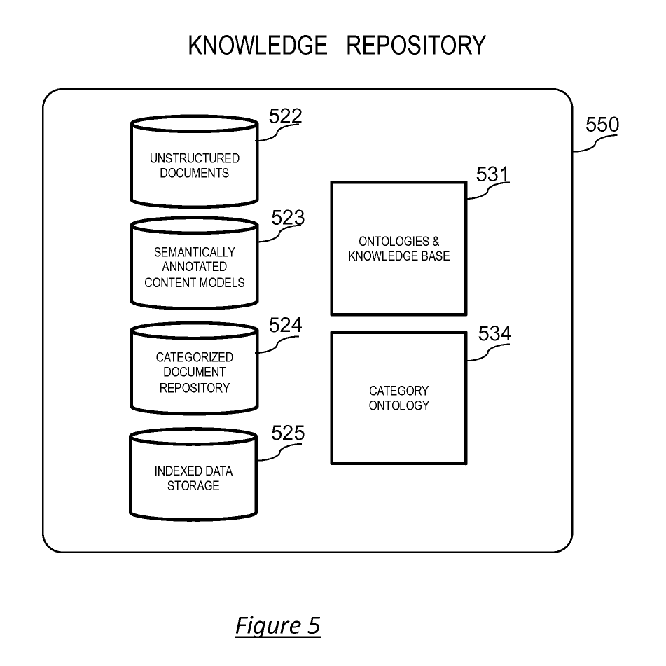

### EXPLANATION OF THE INVENTION

1. The application resides in a mobile device or smartphone 100. The activation button prominently appears with easy access to it while having a voice or video conversation 104. Once activated it announces the present session is getting recorded 125.

2. The recordings take place within the device 125. It records audio and video conversation from the beginning of the conversation or from any fragment to any fragment. The audio and video conversations can be conference calls as well 165 and 170.

3. A specific text message session using the device's messaging system or chat sessions using Facebook, Yahoo, MSN, Google Chat, AOL and other instant chat messaging system, get extracted upon selecting and clicking the “Transfer” button transfers them to the Cloud raw data server 175 185 131.

4. The application also allows transferring any type of document, web pages or multimedia by selecting the transfer button that appears when selected “Save as” either by right click or double click a document 105 106. The Application also allows an email to forward to the server for further integration to the semantic knowledge repository 106 131.

5. The recording sessions get deactivated automatically in the case of voice or video conversations 125.

6. Once deactivated, if connected with WiFi or cellular data, the conversation or online session gets transferred to the cloud server 131.

7. The user can attach a note to any type of document before the transfer to the remote server takes place. This can include a name, short description and some key words 104.

8. The transferred document automatically attaches the geo location, time stamp and owner's information 131.

9. From the server an engine converts all conversations and files to texts and documents 522. For this purpose a number of machine-based information extraction methods 511 are applied for different types of documents that include:
For video files the video information extraction that covers conversion of audio to text and inclusion of information related to events, objects, movements and activities;
For audio documents based on audio transcription using speech recognition programs and natural language processing for extracting information from unstructured text documents.
In a case, where the document comprises of multiple data types, for example, a mix of video, image, and text information, needed combination of information extraction methods are used.

10. With the help of an ontology-based information extraction and indexing engine 512 these documents 522 get translated to semantically annotated content models 523. This process consists of several steps: the linguistic preprocessing stage comprises processes such as sentence boundary determination, stop-word elimination, suffix stripping from words, removal of html tags and other clutters, part of speech tagging, morphological analysis, etc. This follows by named entities recognition analysis, date normalization, measurement tagging and semantic annotation using domain ontologies and knowledge base. If there is multiple matches for an entity found in the ontologies the following process of resolving ambiguity takes place: analysis or the direct indirect relationships with other entities, proximity analysis of related entities and entity refinement with the help of subset analysis.

11. The resulting outcome in the form of semantically annotated content models is placed in the relevant repository 523.

12. At the time of annotation processing a multi-paradigm information management index system 512 generates and stores indexed data of the document. This enables performing queries 600 over texts, annotations, metadata and ontologies prompting superior quality answers.

13. The context-based categorization engine 513 using category ontology 534 classifies the semantically annotated information module and stores a copy of the related document in Categorized document repository 524, which is an integral part of the searchable knowledge repository, under the relevant classification.

14. A notification is sent to the owner in order to assign security level to the document. Level 1—the highest security level makes the document encrypted and accessible to only the owner. Level 2—makes in accessible to predefined group of people, Level 3—makes it accessible to people within the repository users and level 4 makes it accessible to all. Unless a new level is assigned the original security level is always stays level 1—the highest security level with encryption.

15. A user receives access to the categorized aforementioned document through corporate knowledge portal by browsing or performing a search 700.

16. A SPRQL based search engine delivers answers to users query by using the relevant information available in the document 600.

### REFERENCES

| | | | |
|---|---|---|---|
| U.S. Pat. No. | August 2006 | Wu et al. | 700/104 |
| 7,099,727 B2 | | | |
| U.S. Pat. No. | September 2004 | Barak et al. | 379/202.01 |
| 6,792,093 B2 | | | |
| U.S. Pat. No. | February 2010 | Goodwin et al. | 707/100 |
| 7,657,546 B2 | | | |
| US 2004/0230572 | November 2004 | Omoigui | 707/3 |
| A1 | | | |
| US 2010/0275054 | October 2010 | Grace et al. | 714/2; 714/57 |
| A1 | | | |
| U.S. Pat. No. | January 2006 | Byers et al. | 379/88.17 |
| 6,987,841 B1 | | | |

1. A system which comprises application with capabilities of recording audio and multimedia conversation or conference calls and transferring this and text or multimedia messages, Internet based text or multimedia instant messages, multimedia or textual documents and emails from any mobile device or smartphones to a remote server; and a cloud system of information storing, audio, video and image files conversion to text data and documents, semantically annotated information models creation, ontologies, rule based annotations, processing resources, category ontology, knowledge repository and categorization engine, data indexing and storage.

2. The system of claim 1, wherein an application system to record, save and retrieve audio and multimedia conversation or conference calls is included.

3. The system of claim 1, wherein the application system includes a retrieving and transferring system of text or multimedia messages, Internet based text or multimedia instant messages.

4. The system of claim 3, wherein it also includes multimedia or textual documents and emails transferring system.

5. The system of claim 1, wherein a system of encoded transfer of data from mobile device and smart phones to a remote server is included.

6. The system of claim 5, wherein the data transfer could be automated or manual.

7. The system of claim 1, wherein a cloud system comprises of data storage, multimedia files to text conversion system, ontology based information extraction and indexing system, context-based categorization system and a knowledge repository system.

8. The system of claim 7, wherein a data storage system of original files received from the mobile device or smart phone is included.

9. The system of claim 7, wherein a system of converting audio, video and image files to text files is included.

10. The system of claim 9, wherein it includes a separate storage system for aforesaid converted files.

11. The system of claim 7, wherein it includes a ontology based information extraction and indexing system that develops semantically annotated content models and data index from converted files and includes rule based annotations system and processing resources system.

12. The system of claim 7, wherein a context-based categorization system is included which using category ontology and semantically annotated content models classified the relevant document.

13. The system of claim 7, wherein a knowledge repository system comprising semantically annotated context modules storage, categorized information repository, data index storage, ontologies and knowledge base and category ontology is provided.

14. A method of knowledge integration from mobile devices and smartphones which comprises capabilities of recording and integrating audio and multimedia conversation or conference calls, text or multimedia messages, Internet based text or multimedia instant messages, multimedia or textual documents and emails from any mobile device or smartphones to a remote knowledge repository.

15. A method of claim 14, wherein data transmission and storage of saved audio and multimedia conversation or conference calls, text or multimedia messages, Internet based text or multimedia instant messages, documents, multimedia files from any mobile device or smart phone to a remote server.

16. A method of claim 14, wherein the stored multimedia, image and text files on the remote server get converted to textual format and documents.

17. A method of claim 14, wherein ontology based information extraction and indexing engines produces semantically annotated content models and store them.

18. A method of claim 17, wherein ontology based information extraction and indexing engines produces data index and store them in data index storage.

19. A method of claim 14, wherein context base categorization engine analyzes semantically annotated content models, classifies them and store in categorized information repository.

20. A method of assigning security level of the document and notifying owner.
